(19) United States
(12) Patent Application Publication
(10) Pub. No.: US 2002/0172760 A1
(43) Pub. Date: Nov. 21, 2002

(54) Apparatus and process for the post-production repair of converted can ends

(76) Inventors: Shu An, Sidney, OH (US); Gregory Howard Butcher, Lima, OH (US)

Correspondence Address: ALCOA INC, ALCOA TECHNICAL CENTER, 100 TECHNICAL DRIVE, ALCOA CENTER, PA, 15069-0001, US

(21) Appl. No.: 10/150,593

(22) Filed: May 17, 2002

Related U.S. Application Data
(60) Provisional application No. 60/291,692, filed on May 17, 2001.

(51) Int. Cl. B05D 3/06; B05D 1/02; B05D 3/02

(52) U.S. Cl. 427/140; 427/421; 427/372.2; 427/551; 156/94

(57) ABSTRACT

A process and an apparatus for the repair of the protective coating on converted can ends comprises a repair agent application station for the selective application of a radiation-curable repair agent onto at least a portion of the converted can ends, a repair agent curing station for the curing of the repair agent applied to the converted can ends, and a transport system for conveying the converted can ends from the repair agent application station to the repair agent curing station.

### RELATED APPLICATION

This application claims the benefit of U.S. Provisional Patent Application Serial No. 60/291,692 filed May 17, 2001 entitled “Apparatus and Process for the Post-Production Repair of Converted Can Ends”.

### BACKGROUND OF THE INVENTION

1. Field of the Invention

The invention generally relates to a process and an apparatus useful in the manufacture of can ends used in the food and beverage packaging industry. More specifically, the invention provides both an apparatus and a process ideally suited for use in the repair of tooling induced damage, which may occur to coated steel can ends during the conversion of a steel shell into a full-open or easy-open food or beverage container or can end.

2. Description of the Prior Art

Many containers for beverages or other products are provided with easy-open can ends, wherein a pull tab attached to a tear strip, which is defined by a score line in the can end, may be lifted to provide an opening in the can end for dispensing the container's contents. Likewise, many food products are sold in metal containers that have ends known in the industry as “full-open ends”, which are designed to facilitate access to the contents without the use of can openers or the like.

By way of example, in the manufacture of an easy-open can end, a can end shell is first formed from a metal sheet product. The can end shell is then conveyed to a conversion press. In the typical operation of a conversion press, a can end shell is introduced between an upper tool member and a lower tool member which are in the open, spaced apart position. A press ram advances the upper tool member toward the lower tool member in order to perform any of a variety of tooling operations such as rivet forming, paneling, scoring, embossing, tab securing, and final staking. After performing a tooling operation, the press ram retracts until the upper tool member and lower tool member are once again in the open, spaced apart position. The partially converted shell is transported to the next successive tooling operation. This sequence continues through a number of operations until an easy-open can end is completely formed and discharged from the press. As one shell leaves a given tooling station or forming operation, another shell is introduced into or indexed into the vacated station, thus continuously repeating the entire easy-open can end manufacturing or conversion process. Conversion presses can operate at speeds that produce in excess of 500 can ends per minute per lane, with some presses having four lanes of tooling producing in excess of 2000 converted can ends per minute.

It has been the practice in the can end industry to continue to strive to reduce the gauge of the metal of the can end. The current practice is to use metal with a gauge of approximately 0.008 inch. While it should by readily apparent that each of the several tooling stations must be rigorously maintained within prescribed operating tolerances, of critical concern in the production of the converted end is the scoring station. The scoring station of the conversion press employs a knife edge tooling member that defines the panel opening in the face of the can end.

Steel sheet product used in the manufacture of can ends has a coating which protects the metal by inhibiting oxidation or rust from forming on the surface of the metal. During the conversion process, damage to the protective coating typically occurs while forming the scoring of the opening panel of the can end. As noted above, in the conversion of the shell into an end with openable features thereon, a score line is formed. This score line defines the opening panel. The opening panel may be hinged to the can end and is torn away by the activation of a tab riveted to the can end. The score line is most likely the location where damage is caused to the pre-conversion, protective coating. Any oxidation on the surface of the can end represents an unattractive product appearance to the consumer.

It is therefore an object of this invention to provide a process for the repair of damage caused to the protective coating of a steel can end during the conversion of an end shell into a converted can end.

It is another object of this invention to provide an apparatus for the repair of damage caused to the protective coating of a steel can end during the conversion of an end shell into a converted can end.

It is yet another object of this invention to provide an economic and safe system, which is easily integrated into existing can end manufacturing lines for the safe and efficient repair of damage caused to can ends during the conversion of shells into converted can ends.

### SUMMARY OF THE INVENTION

The invention provides both a process and an apparatus for the repair of the protective coating on converted can ends. The apparatus includes a repair agent application station for the selective application of a repair agent onto the desired portion of the converted can ends, a repair agent curing station for the treatment or curing of the repair agent applied to the converted can ends, and a transport system for conveying the converted can ends through the repair agent application station and the repair agent curing station.

The repair agent application station includes a spray mechanism for spraying the repair agent onto the converted can ends. Preferably, the spray mechanism includes a nozzle capable of being preheated, rotated, and turned on and off at a high rate of speed.

The repair agent curing station includes a radiation source for curing or hardening the repair agent on the converted can ends. The repair agent curing station also includes a shielding for containing any unplanned excursion of radiation from the repair agent curing station.

As noted above, the apparatus includes a transport system for conveying the converted can ends from the repair agent application station to the repair agent curing station. Preferably, the transport system includes a conveyance system, having a first transfer belt for conveyance through the repair agent application station, a second transfer belt for conveyance through the repair agent curing station, and transition means for transferring the converted can ends from the first to the second transfer belt.

The process of this invention includes several post can end conversion procedures. First, preferably by means of a spraying operation, a desired repair agent is selectively applied onto at least a portion of the converted can ends. Preferably, the coating is applied onto the score line, so as to coat that portion of the converted can end where the previously applied and cured coating has been damaged during conversion of the shell into the converted end. The can end so treated with a repair agent is conveyed from the repair agent application station to a repair agent curing station. In the repair agent curing station the repair agent on the converted can end is cured or hardened by irradiating the repair agent on the converted can end with a type of radiation that is capable of causing the chemical and/or physical reactions that affect curing or hardening in the repair agent. Upon traversing the repair agent curing station, the repaired can-end may be subject to inspection prior to discharge into an appropriate receiving station.

### BRIEF DESCRIPTION OF THE DRAWINGS

The above as well as other features and advantages of the present invention can be more fully appreciated through consideration of the detailed description of the preferred embodiment in conjunction with the several figures.

FIG. 1 is a schematic representation of the process and apparatus of this invention.

FIGS. 2A and 2B are schematic side elevation and plan views respectively of the apparatus of this invention illustrating a portion of the repair agent application station and conveyance system as shown in detail in connection with FIGS. 3 and 4 and FIGS. 5 and 6, respectively.

FIG. 3 is a schematic illustration of an elevational view of a sub-assembly of the instant apparatus consisting of a repair agent application station according to this invention.

FIG. 4 is a plan view of the station shown in FIG. 3.

FIG. 5 is a schematic illustration of a sub-assembly conveyance system showing multiple elevations and onto which is subsequently incorporated a curing station.

FIG. 6 is a schematic illustration of a sub-assembly conveyance system showing multiple elevations and onto which is mounted a curing station.

FIG. 7 is a schematic, side elevation view of the sub-assembly conveyance system.

FIG. 8 is a perspective view of a preferred nozzle of this invention used for spraying the repair agent onto the converted can ends.

FIGS. 9A, 9B and 9C are top, rear and side views, respectively, of a preferred nozzle of this invention used for spraying the repair agent onto the converted can ends.

FIGS. 10A and 10B are a top plan view and a cross sectional view, respectively, of a conventional converted can end.

### DETAILED DESCRIPTION OF THE PREFERRED EMBODIMENT

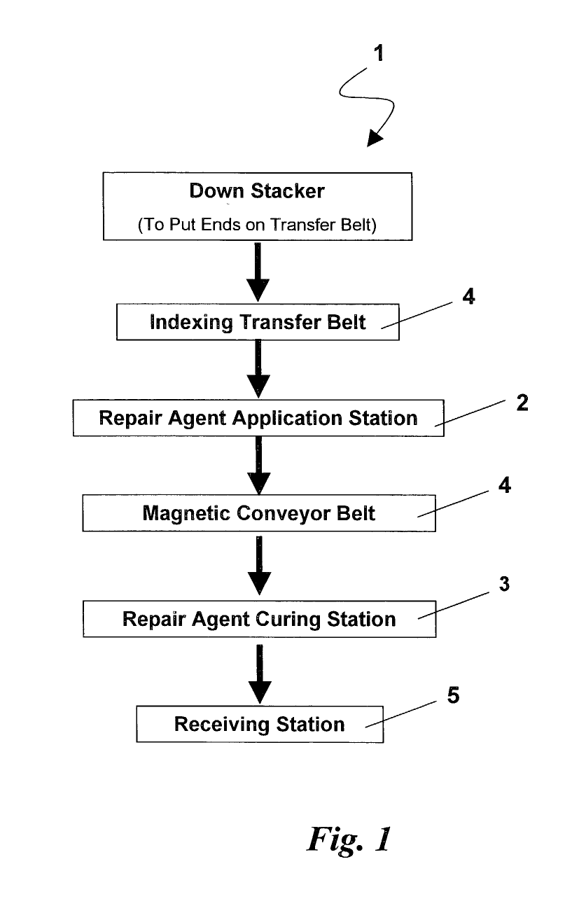

Tuning to FIG. 1 it can be appreciated that the invention provides both a process and an apparatus for the repair of the protective coating on converted can ends. The apparatus represented in block diagram form is generally indicated by the reference character 1 and includes a repair agent application station 2 having means for the selective application of a repair agent onto at least a portion of the converted can ends, a repair agent curing station 3 having means for the treatment or curing of the repair agent applied to the converted can ends, and a transport system 4 for conveying the converted can ends through the repair agent application station 2 and the repair agent curing station 3. The process of this invention includes several post can end conversion procedures. First, preferably by means of a spraying operation in the repair agent application station 2, a desired repair agent is selectively applied onto at least a portion of the converted can ends, which will be described in detail below. The can end so treated with a repair agent is conveyed from the repair agent application station to the repair agent curing station by the transport system 4. Upon traversing the repair agent curing station 3, the repaired can-end may be subject to inspection prior to discharge into an appropriate receiving station 5.

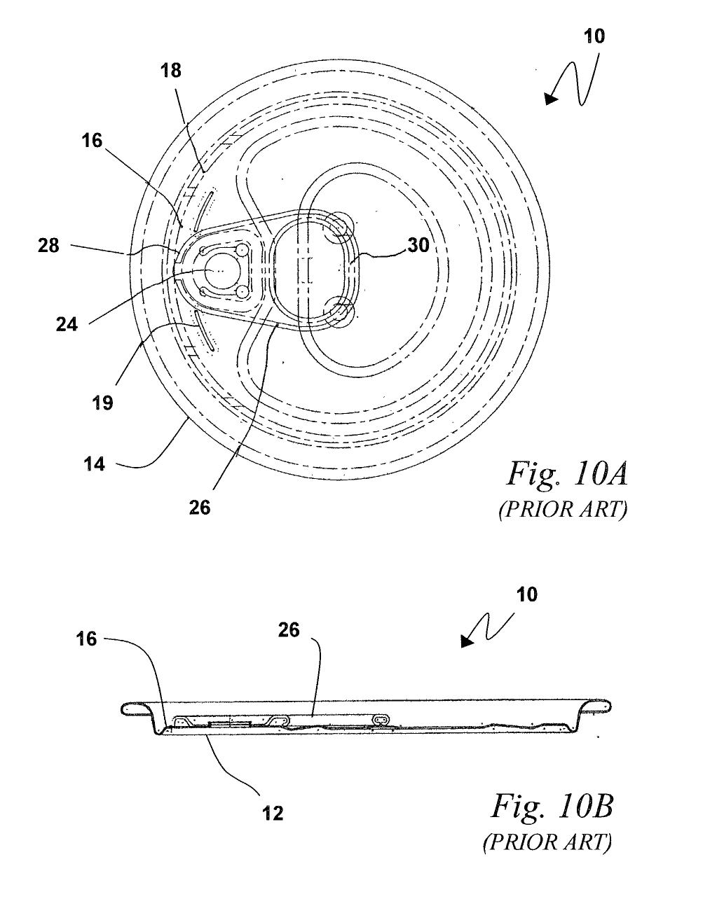

Considering briefly FIGS. 10A and 10B, there is illustrated a conventional, converted can end incorporating features that are well know in the art. Can end 10 has an end panel 12 of generally circular shape which includes a circumferentially extending raised edge 14 for attaching the can end 10 to a suitable cylindrical beverage can (not shown) or the like. In general the can end 10 will be manufactured of a relatively ductile metal such as aluminum, but it may be made from steel, or form other acceptable materials as required. The present invention is primarily directed to can ends manufactured from steel shells and provides both a method and apparatus for repairing damage done to steel can ends in the course of the conversion process, as described elsewhere herein. A retained tear strip 16 extends across can end 10 from a position spaced inwardly of a raised edge 14 to approximately the center of can end 10. Tear strip 16 is defined by a generally V-shaped score 18. The tear strip 16 is typically re-enforced by means of a bead 19 that is formed into the panel 16. Pull-tab 26 is provided with a nose portion 28 and a finger portion 30. During the conversion process, the score 18 is defined in the panel during a step prior to the step in which the tab 26 is attached to the can end by means of the rivet 24 staking operation. In the conversion of a steel shell, damage to the coated material may be obscured from view by the pull-tab. The present invention provides a method for repairing the damage to the complete score line, even that portion of the score line beneath the nose tab.

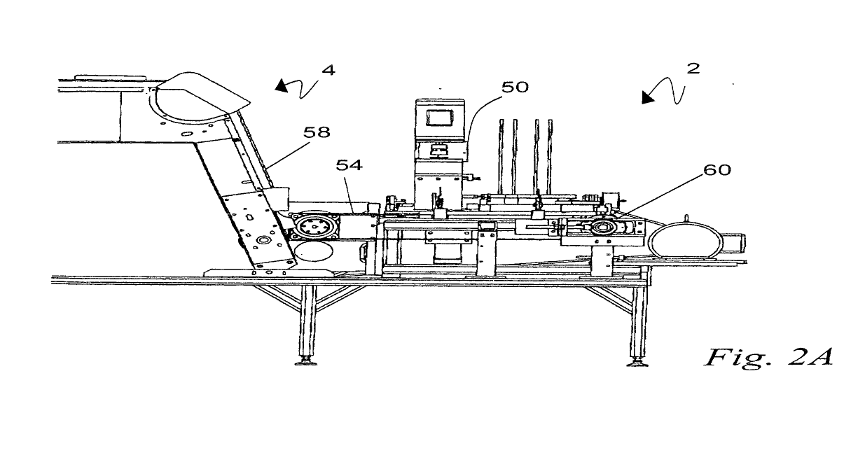

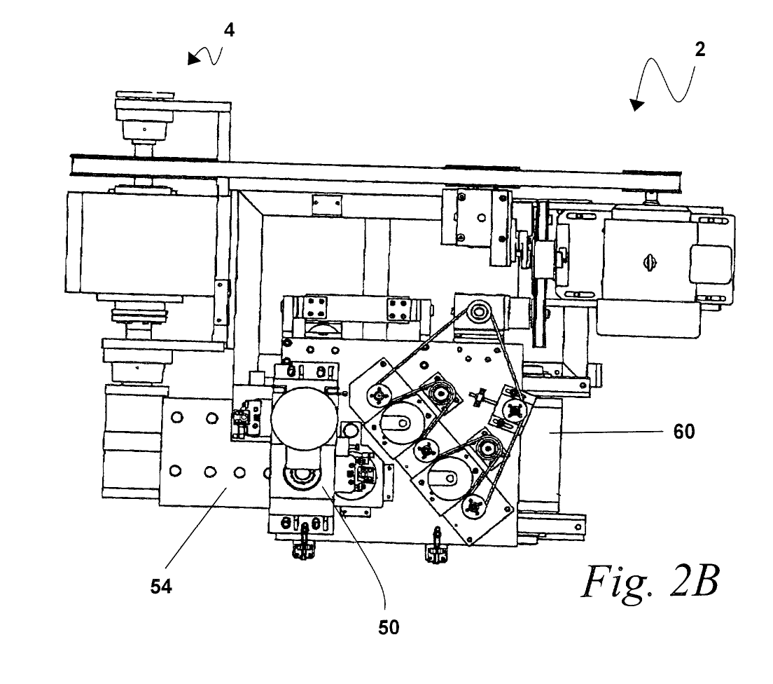

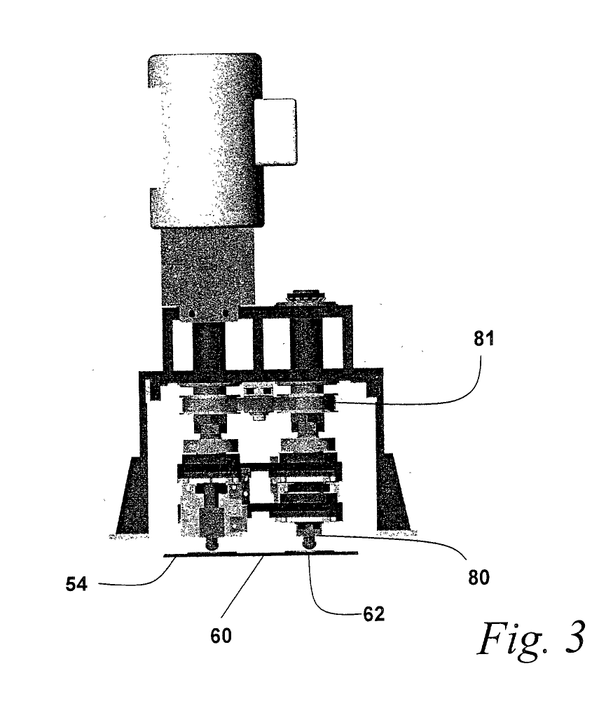

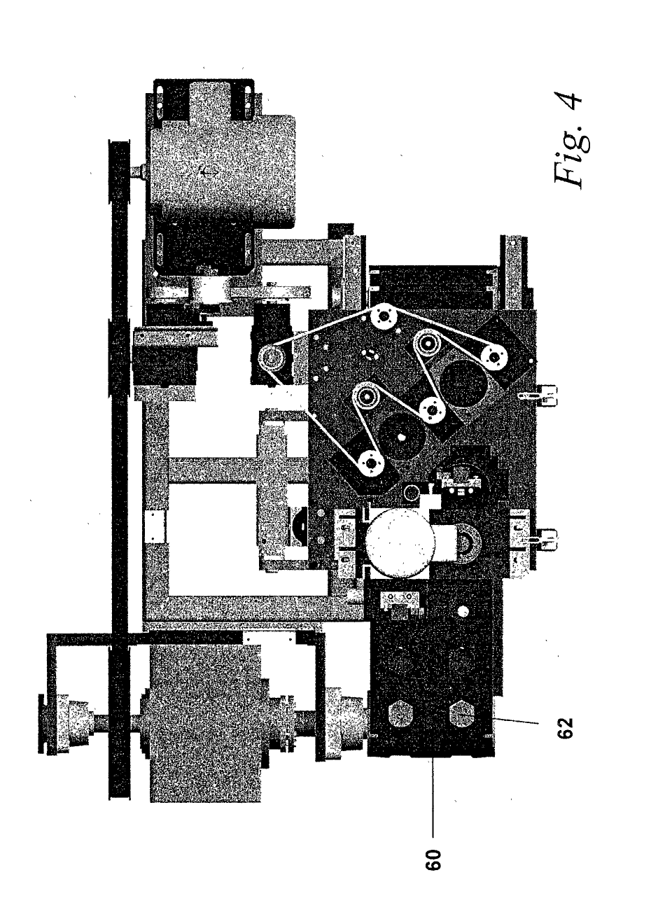

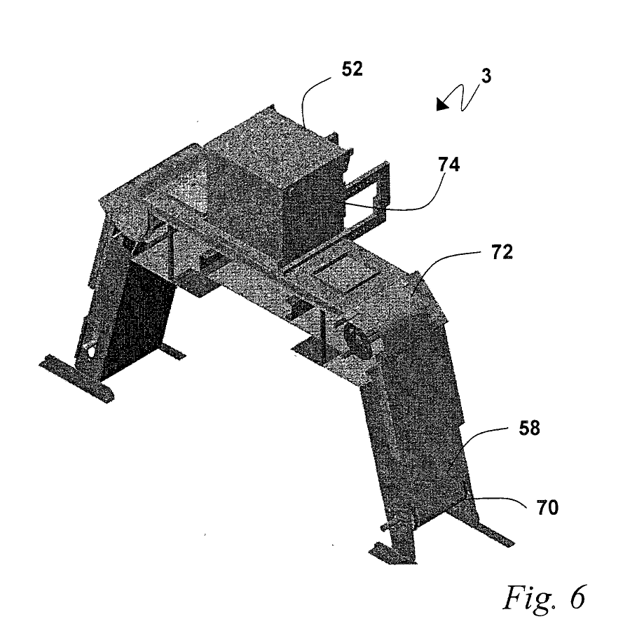

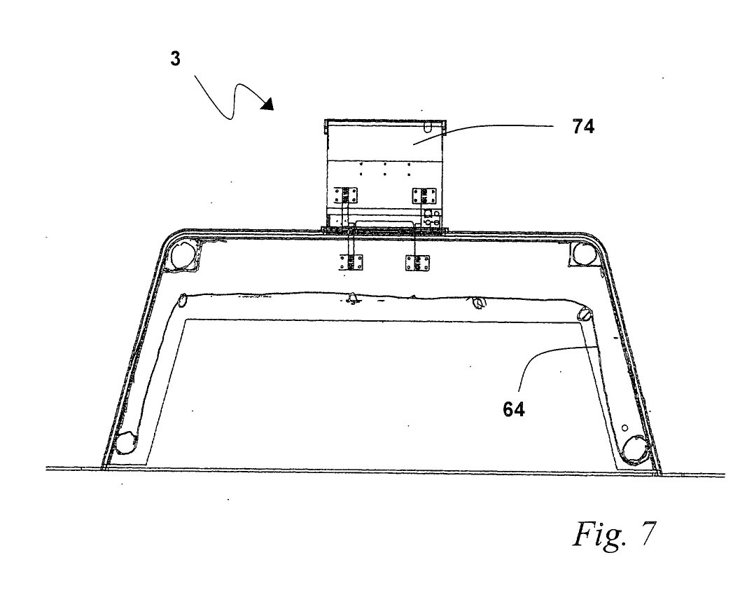

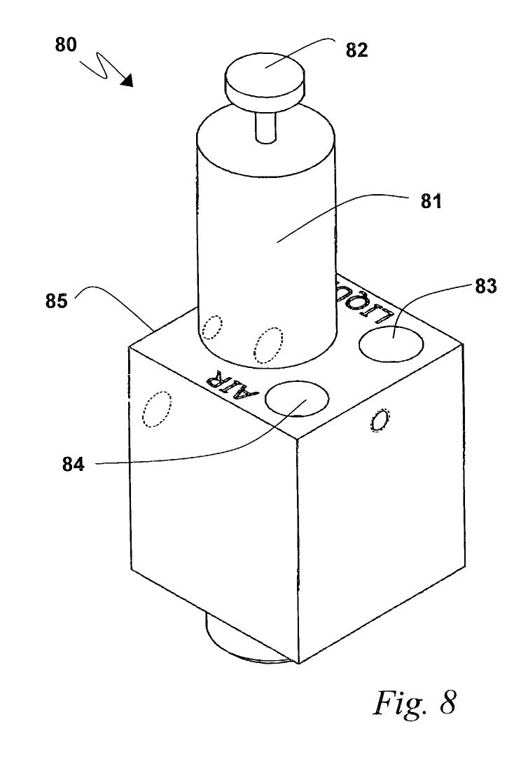

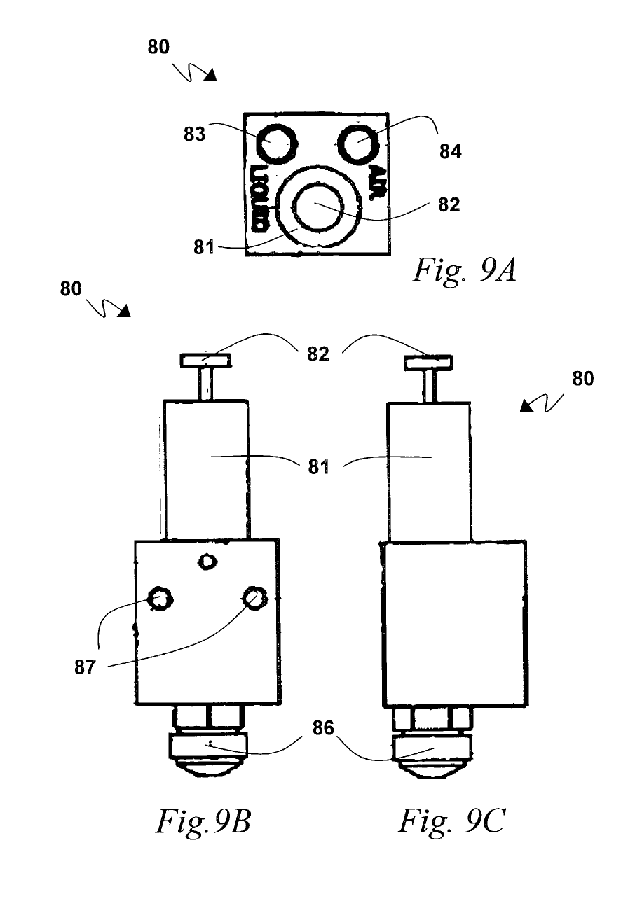

Returning to FIG. 1 and taking into consideration FIGS. 2 through 9, the process and apparatus of this invention will be more fully appreciated. The repair agent application station 2 for selectively applying a repair agent onto the can end 10 includes spray means 50 for spraying the repair agent onto said converted can ends 10. In a preferred embodiment of the process of the invention, the repair agent is applied by a nozzle 80 which may be preheated and through which the repair agent is combined with a predetermined air flow mix by which the fluid repair agent is atomized and applied to the surface of the can end. Additionally, the nozzle may be subjected to high-speed rotation, approximately 1500 rpm, by means of a rotation system to ensure adequate coating of the can end. It is believed that maintaining the nozzle at a predetermined temperature sufficient to facilitate the flow of the repair agent will allow the repair agent to flow onto the surface of the can end and under the tab nose and about the rivet structure, thus fully coating surfaces potentially damaged during the conversion process. In addition to the aforementioned attributes of the nozzle, it is essential to be able to turn the nozzle on and off at high speeds. Due to the high speed, continuous nature of the lid repair process of this invention, the nozzle is typically on for only about 40 milliseconds for each converted can end repair agent application. The nozzle response delay, the time for activation and deactivation of the nozzle, can only be about 5 milliseconds. A preferred nozzle, as manufactured by Technology & Services, Inc., Chillicothe, Ohio, is depicted in perspective in FIG. 9. Top, back and side views of this preferred nozzle are depicted in FIGS. 10A, 10B and 10C, respectively. The nozzle is operated by a solenoid, which includes a solenoid adjustment knob 82 and a solenoid body 81. A liquid inlet port 83 and an air inlet port 84 are contained on the preferred nozzle 80 which allows for mixing air with the repair agent to atomize the repair agent for spraying on the damaged converted can end 10. Mounting holes 87 are provided for easy inclusion into the apparatus of this invention. In addition, this preferred nozzle has features not seen on other nozzles. For example, the plunger tip to turn the nozzle on and off is located internally in close proximity to the orifice of the nozzle head 86. This allows the nozzle to turn on and off at a fast rate. Also, the plunger is guided in holes containing a self-lubricating material, such as a perfluorinated polymer. The fluid volume that is sprayed with the nozzle can also be adjusted. A typical spraying angle from the orifice is about 18°. The nozzle 80 is adapted to orbital motion generally about the can-end rivet, at about approximately 1500 rpm to fully coat the potentially damaged portions of the steel end by means of gear and motor drive system 81.

The repair agent curing station 3 for the treatment of the repair agent includes a radiation source 52 for the generation and controlled transmission of a form of radiation that is capable of curing or hardening the repair agent. The radiation for curing the coating may be electrons, such as for example an electron beam, or electromagnetic radiation, such as for example ultraviolet (UV) light. Preferably, the repair agent is a fluid formulated for curing or hardening by irradiation with electron beams. An example of a repair agent that is cured by electron beam irradiation is sold under the trademark “Sun Beam LE” by Sun Chemical Company.

As noted above, the apparatus includes a transport system 4 for conveying said converted can ends from the repair agent application station 2 to the repair agent curing station 3. Preferably, the transport system 4 comprises a first transfer belt means 54, a second transfer belt means 56, and transition means 58 disposed therein between for effecting transfer of the converted can ends from the first 54 to the second 56 transfer belt means. The first transfer belt means 54 is adapted to index the converted can ends 10 into and out of the repair agent application station 2 such that each converted can end 10 is maintained in a fixed position at the repair agent application station for a predetermined period of time for the application of the repair agent. Preferably, the first transfer belt means 54 of the apparatus comprises a first endless belt 60 having a plurality of apertures 62 therein, each of which aperture is adapted to receive and index one of the converted can ends for processing into and out of the repair agent application station, such that each of the converted can ends is maintained in a fixed position at the repair agent application station for a predetermined period of time for the application of the repair agent. In this preferred embodiment, the first transfer belt is referred to as an indexing transfer belt.

The second transfer belt means 56 is adapted to convey the converted can ends with the applied repair agent through the repair agent curing station 3 such that the converted can ends 10 are exposed within the repair agent curing station 3 for a predetermined period of time to a methodology for treatment or curing of the repair agent. Preferably, the second transfer belt means 56 includes a second endless belt 64 that is supported in a housing 66 and further includes a means for retaining said converted can ends thereon. In a preferred embodiment, the aforedescribed housing 66 includes magnetic means 68 disposed below at least a portion of the second endless belt whereby converted, steel can ends are retained on the second endless belt by the magnetic means. The magnetic means may include permanent magnets or electromagnets. In this preferred embodiment, the second transfer belt is referred to as a magnetic conveyor belt. The second endless belt 64, which conveys the converted can ends from a first elevation 70 through a second elevation 72, and the housing in which the second endless belt is supported includes a shielding 74 for enclosing at least a portion of said repair agent curing station. The shielding 74 controls the unplanned excursion of radiation from the repair agent curing station. The shielding 74 is made of material that is not penetrable by the type of radiation used for curing the repair agent, and encloses at least the radiation source and target, which is the converted can end.

The process of this invention includes several post, can-end conversion procedures. First, preferably by means of a spraying operation, a desired repair agent is selectively applied onto at least a portion of the converted can ends. Preferably the coating is applied onto the score line, so as to coat that portion of the converted can end where the previously applied and cured coating has been damaged during conversion of the shell into the converted end. The can end so treated with a repair agent is conveyed from the repair agent application station to a repair agent curing station. Upon traversing the repair agent curing station, the repaired can-end may be subject to inspection prior to discharge into an appropriate receiving station.

In a preferred embodiment of the invention, the repair agent is applied by a nozzle 80 which may be preheated and through which the repair agent is combined with a predetermined air flow mix by which the fluid repair agent is atomized and applied to the surface of the can end. Additionally, the nozzle 80 may be subjected to high speed rotation with orbital motion generally about the can-end rivet, at about approximately 1500 rpm to ensure adequate coating of the can end. It is believed that maintaining the nozzle at a predetermined temperature sufficient to facilitate the flow of the curing agent will allow the repair agent to flow onto the surface of the can end and under the tab nose and about the rivet structure, thus fully coating surfaces potentially damaged during the conversion process.

As the first transfer belt means conveys the end in an indexed sequence and locates the end beneath the nozzle 80, the repair agent is applied. The uncured-coated end is indexed from beneath the nozzle 80 to the end of the first transfer belt means 56. The can-end is then engaged by the second transfer belt means and magnetic means 68 disposed beneath the second transfer belt means 58. It is to be appreciated that the second endless belt described in a preferred embodiment herein may define both the transition means for conveying the end between the repair agent application station 2 and the repair agent curing station 3 and the means for conveying the uncured-coated end through the repair agent curing station 3 where curing takes place.

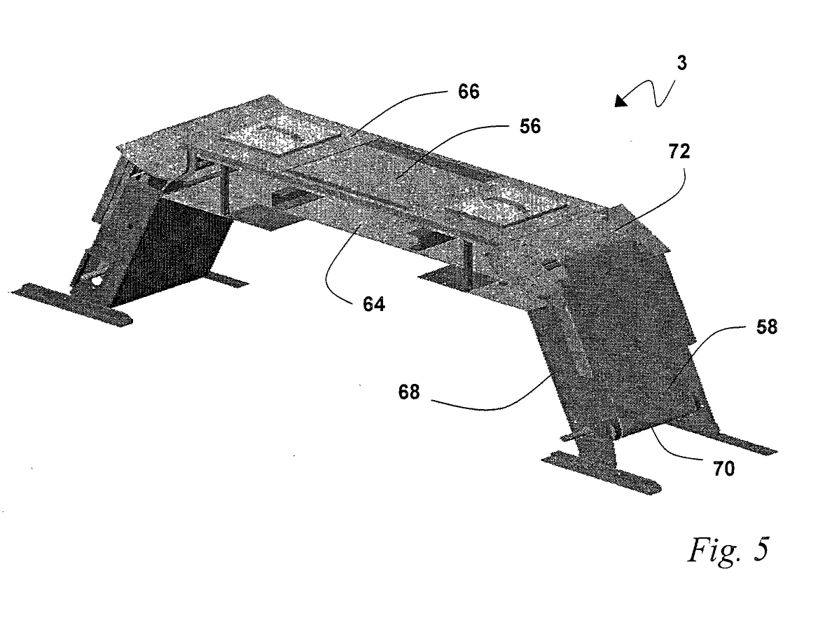

As the second transfer belt means 58 conveys the end from the repair agent application station to the repair agent curing station, it is preferred that the end be conveyed from a first elevation to a second elevation. As shown in the preferred embodiment of FIG. 5, the repair agent curing station 3 is at a higher elevation than the repair agent application station. This difference in the relative elevations of the two stations facilitates the construction of the shielding 74 appropriate to the use of election beam technology used in the preferred curing process.

Curing may be accomplished by conveying the ends through the repair agent curing station at a constant rate of speed and adjusting the intensity of the radiation. A commercially available radiation system can be used in conjunction with the repair agent to provide effective post-op repair of the score line in a steel end.

After the completion of the curing process the repaired can-end may be stacked and packaged in a technique well known in the packaging industry or the ends may be subject to a final inspection to verify the complete coating of the score. For example, a vision system may be employed to inspect each end or a predetermined sample from the repaired ends.

What has been described is an improved process and apparatus for the post-conversion repair of easy-open steel ends.

What is claimed is:

1. An apparatus for the repair of the protective coating on converted can ends comprising:
(a) a repair agent application station having means for the selective application of a repair agent onto said converted can ends;
(b) a repair agent curing station having means for the curing of said repair agent on said converted can ends; and
(c) transport means for conveying said converted can ends through said repair agent application station and said repair agent curing station.

2. The apparatus of claim 1, wherein said repair agent application means comprises a nozzle for combining air with said repair agent for spraying onto said converted can ends.

3. The apparatus of claim 2, wherein said nozzle is capable of being preheated.

4. The apparatus of claim 2, wherein said nozzle is rotatable.

5. The apparatus of claim 2, wherein said nozzle response delay for activation and deactivation is about 5 milliseconds or less.

6. The apparatus of claim 1, wherein said repair agent curing station comprises a means for generating and controlling the transmission of an electron beam.

7. The apparatus of claim 1, wherein said repair agent curing station comprises a means for generating and controlling the transmission of electromagnetic radiation.

8. The apparatus of claim 1, wherein said transport means comprises a first transfer belt means and a second transfer belt means, and a transition means disposed therein.

9. The first transfer belt means of claim 8 comprising: a first endless belt, said first endless belt is adapted to index said converted can ends into and out of said repair agent application station, said first endless belt having a plurality of apertures, said apertures adapted to receive therein one of said converted can ends for processing through said repair agent application station.

10. The second transfer belt means of claim 8 comprising: a second endless belt, said second endless belt supported in a housing, said housing further comprising a means for retaining said converted can ends on said second endless belt.

11. The housing of claim 10, wherein said retaining means comprises a magnetic means when said converted can ends are comprised of steel.

12. The housing of claim 10 further comprising a shielding for controlling the unplanned excursion of radiation from said repair agent curing station.

13. The second endless belt of claim 10, wherein said converted can ends are conveyed from a first elevation to a second elevation.

14. The apparatus of claim 1, wherein said transport means comprises a first transfer belt means and a second transfer belt means, wherein said first transport means conveys said converted can ends to said second transfer belt means.

15. The first transfer belt means of claim 14 comprising: a first endless belt, said first endless belt is adapted to index said converted can ends into and out of said repair agent application station, said first endless belt having a plurality of apertures, said apertures adapted to receive therein one of said converted can ends for processing through said repair agent application station.

16. The second transfer belt means of claim 14 comprising: a second endless belt, said second endless belt supported in a housing, said housing further comprising a means for retaining said converted can ends on said second endless belt.

17. The housing of claim 16, wherein said retaining means comprises a magnetic means when said converted can ends are comprised of steel.

18. The housing of claim 16 further comprising a shielding for controlling the unplanned excursion of radiation from said repair agent curing station.

19. The second endless belt of claim 16, wherein said converted can ends are conveyed from a first elevation to a second elevation.

20. An apparatus for the repair of the protective coating on converted can ends comprising:
(a) a repair agent application station for selectively applying a repair agent onto said converted can ends;
(b) a repair agent curing station for the treatment of said repair agent on said converted can ends; and
(c) a transport system for conveying said converted can ends through said repair agent application station and said repair agent curing station.

21. The apparatus of claim 20, wherein said repair agent application station comprises a nozzle for combining air with said repair agent for spraying onto said converted can ends.

22. The apparatus of claim 21, wherein said nozzle is capable of being preheated.

23. The apparatus of claim 21, wherein said nozzle is rotatable.

24. The apparatus of claim 21, wherein said nozzle response delay for activation and deactivation is about 5 milliseconds or less.

25. The apparatus of claim 20, wherein said repair agent curing station comprises a means for generating and controlling the transmission of an electron beam.

26. The apparatus of claim 20, wherein said repair agent curing station comprises a means for generating and controlling the transmission of electromagnetic radiation.

27. The apparatus of claim 20, wherein said transport system comprises a first transfer belt means and a second transfer belt means, and a transition means disposed therein.

28. The first transfer belt means of claim 27 comprising: a first endless belt, said first endless belt is adapted to index said converted can ends into and out of said repair agent application station, said first endless belt having a plurality of apertures, said apertures adapted to receive therein one of said converted can ends for processing through said repair agent application station.

29. The second transfer belt means of claim 27 comprising: a second endless belt, said second endless belt supported in a housing, said housing further comprising a means for retaining said converted can ends on said second endless belt.

30. The housing of claim 29, wherein said retaining means comprises a magnetic means when said converted can ends are comprised of steel.

31. The housing of claim 29 further comprising a shielding for controlling the unplanned excursion of radiation from said repair agent curing station.

32. The second endless belt of claim 29, wherein said converted can ends are conveyed from a first elevation to a second elevation.

33. The apparatus of claim l, wherein said transport means comprises a first transfer belt means and a second transfer belt means, wherein said first transport means conveys said converted can ends to said second transfer belt means.

34. The first transfer belt means of claim 33 comprising: a first endless belt, said first endless belt is adapted to index said converted can ends into and out of said repair agent application station, said first endless belt having a plurality of apertures, said apertures adapted to receive therein one of said converted can ends for processing through said repair agent application station.

35. The second transfer belt means of claim 33 comprising: a second endless belt, said second endless belt supported in a housing, said housing further comprising a means for retaining said converted can ends on said second endless belt.

36. The housing of claim 35, wherein said retaining means comprises a magnetic means when said converted can ends are comprised of steel.

37. The housing of claim 35 further comprising a shielding for controlling the unplanned excursion of radiation from said repair agent curing station.

38. The second endless belt of claim 35, wherein said converted can ends are conveyed from a first elevation to a second elevation.

39. A process for the repair of the protective coating on converted can ends comprising the steps of:
(a) providing a radiation-curable, fluid repair agent;
(b) atomizing said radiation-curable, fluid repair agent with air inside a nozzle;
(c) spraying said atomized repair agent onto at least a portion of the surface of a converted can-end; and
(d) curing said sprayed repair agent on said converted can end by irradiation from a radiation source.

40. A process for the repair of the protective coating on converted can ends comprising the steps of:
(a) providing an electron-beam curable, fluid repair agent;
(b) atomizing said electron beam-curable, fluid repair agent with air inside a nozzle;
(c) spraying said atomized repair agent onto at least a portion of the surface of a converted can-end; and
(d) curing said sprayed repair agent on said converted can end by irradiation from at least one electron beam source.

41. The process of claim 40, wherein the nozzle is rotated in an orbital fashion generally around said converted can end rivet.

42. The process of claim 40, wherein the nozzle is preheated.

43. The process of claim 40, wherein the atomized repair agent is sprayed for about 400 milliseconds or less.
